(19) United States
(12) Patent Application Publication
(10) Pub. No.: US 2026/0018919 A1
(43) Pub. Date: Jan. 15, 2026

(54) Vehicle Charging Circuit With Changeover Switches For Isolating A Load AC Connection

(71) Applicant: Schaeffler Technologies AG & Co. KG, Herzogenaurach (DE)

(72) Inventors: Franz Pfeilschifter, Walderbach (DE); Martin Götzenberger, Ingolstadt (DE); Manuel Brunner, Teunz (DE)

(73) Assignee: Schaeffler Technologies AG & Co. KG, Herzogenaurach (DE)

(21) Appl. No.: 19/332,342

(22) Filed: Sep. 18, 2025

Related U.S. Application Data
(63) Continuation of application No. PCT/EP2024/055247, filed on Feb. 29, 2024.

(30) Foreign Application Priority Data
Mar. 22, 2023 (DE) 10 2023 202 546.9

(51) Int. Cl. H02J 7/02; B60L 53/16; H02J 7/00; H02M 1/42; H02M 7/217

(52) U.S. Cl. CPC H02J 7/02; H02J 7/0029; H02M 7/2173; B60L 53/16; B60L 2210/10; H02J 2207/20; H02M 1/42

(57) ABSTRACT

A multi-phase vehicle charging circuit equipped with an AC charging connector and with a load AC connector is provided. The charging connector is connected to an AC side of a rectifier circuit. The load AC connector is connected to a neutral conductor of the vehicle charging circuit and to a first phase of the AC side. At least one changeover switch connects at least one further phase of the AC side optionally to the neutral conductor or to an associated phase connector of the AC charging connector.

### CROSS-REFERENCE TO RELATED APPLICATIONS

This application claims the benefit of PCT Application PCT/EP2024/055247, filed Feb. 29, 2024, which claims priority to German Application DE 10 2023 202 546.9, filed Mar. 22, 2023. The disclosures of the above applications are incorporated herein by reference.

### TECHNICAL FIELD

The disclosure relates to a vehicle charging circuit with changeover switches for isolating a load AC connection.

### BACKGROUND

Electrically operated vehicles have a rechargeable battery which assists the electric drive. In order to charge this rechargeable battery, electrically operated vehicles have a charging connector, such as an AC charging connector. Furthermore, it is known that the rechargeable battery of such vehicles can also be used to operate a load outside the vehicle. In order to connect this load to the vehicle on-board electrical system, a load AC connector is used, for example in the form of a socket, to connect loads. As a result, loads which are designed to operate using mains voltage (AC voltage) of an electricity supply grid can also be operated in a mobile manner by way of the rechargeable battery of the vehicle.

Safety precautions must be met both for the charging connector and for the load AC connector in order to avoid voltage being applied at the load AC connector during driving and in order to avoid a dangerous voltage being applied at the load AC connector in the event of an accident for example. In the case of an all-pole isolation, this necessitates four disconnect switches (for 3 phases and the neutral conductor connector) for the charging connector and two disconnect switches (for the phase potential and the neutral conductor potential of the load AC connector) for the load AC connector. These disconnect switches are cost-intensive.

### SUMMARY

The disclosure provides an option for how the outlay for safety precautions to protect against contact voltages at a charging connector and at a load AC connector can be reduced.

In some implementations, devices that are connected downstream of an AC charging connector (charging connector for short) are disconnected in part also to protect the load AC connector (load connector for short). The charging connector has a plurality of phases and one neutral conductor. One of these phases and the neutral conductor are connected to the load connector. For at least one further or other phases of the charging connector, a simple disconnect switch, which is connected downstream of the charging connector, is not used, but rather disconnection is carried out by a changeover switch. The changeover switch in the corresponding switching position not only disconnects the relevant phase of the charging connector, but also connects the relevant phase to the neutral conductor. As a result, phase and neutral conductor of the load connector can be connected to a phase and the neutral conductor of the charging connector, where the at least one changeover switch on the one hand disconnects a further phase of the charging connector and on the other hand connects to the neutral conductor. This also allows combination of the phases of a charging circuit (such as a power factor correction filter) by way of the at least one changeover switch, so that a plurality of phases of the power electronics of the charging circuit can contribute to converting a current into AC voltage (for output at the load connector). The use of a changeover switch allows the (alternate) disconnection of a relevant phase of the charging connector and a phase or neutral conductor connector of the load connector. Therefore, only one changeover switch is necessary (for a phase) and not two changeover switches which can disconnect the relevant phase for the load connector and for the charging connector. This reduces the outlay and the costs.

Therefore, a multi-phase vehicle charging circuit is described, which has an AC charging connector (charging connector for short) and a load AC connector (load connector for short). The charging circuit is bidirectional and allows both the feeding of power into the charging connector and the output of power at the load connector. The charging connector may be a connector for wired charging for vehicles. The charging connector is provided in an outer skin of the vehicle. As a result, the charging connector can be contacted from outside, in order to feed in power (in the form of alternating current).

The charging connector complies with a standard for charging vehicles, such as a standard for three-phase or multi-phase charging of vehicles using an AC voltage. The load connector may be designed like a socket for outputting mains voltage, i.e. AC voltage of a supply grid. The load connector is designed to be single-phase and has (in addition to a ground connection that is possibly present) a neutral conductor connector or contact and a phase connector or contact. The load connector can be designed in compliance with a NEMA or a CE standard (or a different national or international standard for sockets of an AC voltage supply grid).

The vehicle charging circuit is accommodated in a vehicle and can be part of a vehicle on-board electrical system or can be connected to a vehicle on-board electrical system (by way of a DC voltage side of a rectifier circuit of the vehicle charging circuit).

The vehicle charging circuit has a rectifier circuit (rectifier for short). The rectifier circuit can rectify an AC voltage into a DC voltage. The rectifier circuit is designed to be multi-phase. In some examples, the number of phases of the rectifier circuit corresponds to the number of phases of the charging connector. The rectifier circuit may be a controlled rectifier circuit. The rectifier circuit is designed for bidirectional power transmission.

The load connector is connected to the charging connector. In some examples, a phase or a phase contact of the load connector is connected to a first phase of the AC side or to a first phase of the rectifier circuit. The phase of the load connector may be connected to a first phase (or a first phase contact) of the charging connector. A neutral conductor contact or a neutral conductor of the load connector is connected to a neutral conductor of the charging circuit, particularly to a neutral conductor (contact) of the charging connector.

The rectifier circuit is designed bidirectionally for at least one of the plurality of phases of the rectifier circuit. As a result, the rectifier circuit can output an AC voltage at its AC side, which is applied at the load connector (owing to the connection to the rectifier circuit). By way of the rectifier circuit, a load connected to the load connector can thus be supplied with AC voltage.

At least one changeover switch connects at least one further phase of the rectifier circuit (or its AC side) optionally to the neutral conductor or to an associated phase connector of the charging connector. At least one changeover switch is therefore connected to the AC side of the rectifier, in order to connect this optionally to an individual phase of the charging connector or to the neutral conductor of the vehicle charging circuit or the charging connector (in the sense of an XOR logic). The at least one changeover switch is connected to a (further) phase of the AC side which differs from the first phase. The first phase is a phase which is connected, without a changeover switch, to a phase contact of the charging connector. The phase of the load connector is connected to the first phase of the rectifier circuit. At least one further phase of the rectifier circuit is connected by way of a changeover switch optionally to a further phase of the charging connector or to the neutral conductors. The at least one changeover switch is thus located in a connection between one phase of the charging connector and the rectifier circuit, which phase differs from the phase which is connected to the load connector.

By way of the at least one changeover switch, the relevant (at least one) phase, which does not correspond to the first phase, can therefore be connected to the neutral conductor. This is used for protecting the load connector. The phase of the rectifier circuit which is connected to the load connector can be connected to the first phase of the charging connector (or an associated first phase contact) directly or by way of a disconnect switch (possibly also designed as a changeover switch, but used as a disconnect switch).

A first phase of the charging connector is therefore connected both to the rectifier circuit (or a first phase thereof) and to the load connector. At least one further phase of the load connector is connected by way of a changeover switch to a corresponding further phase of the rectifier circuit. The phases of the charging connector which are not connected to the load connector are connected by way of a changeover switch to the rectifier circuit. The relevant changeover switch can as a result optionally connect the relevant phase of the rectifier circuit to the neutral conductor or to the individual associated phase of the charging connector.

The vehicle charging circuit may be designed to be three-phase. The rectifier circuit includes 3 phases. Likewise, the charging connector has 3 phase contacts or phases. The first phase of the rectifier circuits or the AC side of the rectifier circuit is connected to a first phase connector or phase contact of the charging connector. The second and the third phase of the rectifier circuit are in each case connected by way of a changeover switch to the corresponding second and third phases of the charging connector. The changeover switches optionally connect the relevant phase of the rectifier circuit to the associated phase of the charging connector or to the neutral conductor. A second phase of the rectifier circuit can therefore be connected by way of a first changeover switch to the relevant phase of the charging connector. The third phase of the rectifier circuit can be connected by way of a second changeover switch to the third phase of the charging connector. The phases of the charging connector can be designed as contacts or as phase connectors. In some examples, these are part of the charging connector.

The first changeover switch connects the second phase of the rectifier circuit to a second phase connector of the charging connector or to the neutral conductor in an optional or selectable manner. Instead of the connection to the neutral conductor, a connection to a potential can be provided, which potential corresponds to the neutral conductor. The second changeover switch connects the third phase of the rectifier circuit to a third phase connector or to the third phase of the charging connector or to the neutral conductor in an optional or selectable manner.

If there are a plurality of changeover switches between rectifier circuit and charging connector, these are switched synchronously. This means that all changeover switches simultaneously either connect the rectifier circuit to an individual phase of the charging connector or connect the rectifier circuit to the neutral conductor. The position of the at least one changeover switch in which the changeover switch connects the rectifier circuit to the charging connector or to the individual phase of the charging connector corresponds to a charging position (i.e. a charging switching state). The switching position in which the at least one changeover switch connects the rectifier circuit to the neutral conductor corresponds to a load supply position (i.e. a load supply switching state). The vehicle charging circuit (or a controller of same) can have a charging state in which the at least one changeover switch is in the charging position. The vehicle charging circuit (or a controller of same) can have a load supply state in which the at least one changeover switch is in the load supply switching state.

In the case of load supply (changeover switch in load supply switching state), the rectifier circuit operates to convert a voltage on a DC voltage side of the rectifier circuit and outputs the converted voltage as AC voltage at the load connector. In the charging position of the changeover switches, the rectifier circuit operates as rectifier and rectifies the voltage that is applied at the charging connector (or on the AC voltage side). The power flow direction is different in the two switching positions.

The charging circuit may include a controller connected to the at least one changeover switch in a controlling manner. The controller is configured, in a charging state, to control the at least one changeover switch to connect the at least one further phase of the AC side to the associated phase connector. In other words, the controller controls the at least one changeover switch in the charging state to connect the rectifier circuit (or its AC voltage side) to the individual phases of the charging connector individually. As a result, multi-phase charging becomes possible. The controller can further have a load supply state. In this load supply state, the controller controls the at least one changeover switch to connect the at least one further phase to the neutral conductor.

In the load supply state, the changeover switches are therefore controlled by the controller such that these connect the further phases of the rectifier circuit to the neutral conductor. In the load supply state, the phases of the rectifier circuit are therefore connected to the neutral conductor by way of the changeover switches. As not all phases at the rectifier circuit are connected to one of the changeover switches that are controlled in this manner (particularly not the phase which is connected to the load connector), the connection to the neutral conductor in the load supply state relates to only a portion of all phases of the rectifier circuit. In the load supply state, the phases which are not connected with the load inflow, i.e. the phases which are connected to a changeover switch, are connected to the neutral conductor by way of the relevant changeover switches.

The controller can further be connected in a controlling manner to the rectifier circuit. The controller can be configured to control the rectifier circuit to rectify a voltage from the AC side to the DC side if the changeover switches are in the charging state. The controller can further be configured to control the rectifier circuit to convert a voltage applied at the DC voltage side of the rectifier toward the AC voltage side. In this case, the controller controls the changeover switches simultaneously to assume the load supply state.

As mentioned, the vehicle charging circuit can have three phases, where the rectifier circuit or its AC side is then also designed to be three-phase. The first phase of the rectifier circuit is connected (directly or by way of a disconnect switch) to the first phase of the charging connector, the second phase is connected by way of the first changeover switch to the second phase of the charging connector, and the third phase of the rectifier circuit is connected by way of the second changeover switch to the third phase of the charging connector. The controller is connected to the two changeover switches and configured to control the two changeover switches simultaneously to connect the second and the third phase of the rectifier circuit either simultaneously to the neutral conductor or to the respective second and third phases of the charging connector.

The rectifier circuit may be a controllable rectifier circuit. The rectifier circuit may be designed as a multi-phase bridge circuit. Each phase of the rectifier circuit has a half bridge of controllable switching elements. In some examples, the rectifier circuit is designed as an active power factor correction (PFC) filter. Therefore, in addition to the half bridges (one for each phase), the rectifier circuit also includes working inductances which are connected upstream of the respective half bridges on the AC voltage side. In other words, the rectifier circuit has an AC voltage side having a plurality of phases or phase connectors, where each phase connector is connected by way of its own working inductance to its own half bridge. Each half bridge has controllable switching elements, so that it is possible to correct the power factor using the effect of the inductances and/or harmonics can be reduced. In some examples, the controller is also connected to the half bridges in order to correspondingly control these.

If a DC voltage is applied on the DC voltage side, then an AC voltage can be generated by corresponding control of the half bridges on the AC voltage side. In the same way, when applying an AC voltage at the individual phase connectors on the AC voltage side of the rectifier, this AC voltage can be rectified (in a controlled manner), where a power factor correction can additionally be performed using the inductances. The half bridges of the power factor correction filter are connected at their ends to the DC voltage side of the rectifier circuit, that is to say to a negative or positive DC voltage potential of the DC voltage side. Each half bridge has a connecting point between the series-connected switching elements. These connecting points form the phases of the AC voltage side and are connected (partially by way of the changeover switches) to the charging connector. The rectifier circuit may be in the form of a Vienna rectifier. The switching elements are semiconductor switching elements, for example, transistors such as IGBTs or MOSFETs.

The vehicle charging circuit can also have a DC-to-DC voltage converter. This is connected downstream of the rectifier circuit. In particular, the DC-to-DC voltage converter can be connected to a DC side of the rectifier circuit. If the vehicle charging circuit has a DC voltage connector, then this is connected to the DC voltage side of the rectifier circuit either directly or by way of the DC-to-DC voltage converter. As a result, the DC-to-DC voltage converter can connect the DC voltage connector of the vehicle charging circuit to the DC side of the rectifier circuit. The controller may also be connected to the DC-to-DC voltage converter in a controlling manner. The DC-to-DC voltage converter can be realized in a galvanically-isolating or non-galvanically-isolating manner.

The vehicle charging circuit may be designed to be three-phase. The second phase of the AC side of the rectifier circuit is connected by way of the first changeover switch to the second phase of the charging connector. The third phase of the AC side of the rectifier circuit is connected by way of a second changeover switch to the third phase of the charging connector. Therefore, a plurality of changeover switches can be provided, which are located between the rectifier circuit and the charging connector. The plurality of changeover switches may be electromechanical changeover switches. Both changeover switches are connected to a common actuator in a force-transmitting manner. The actuator (for example an electromagnetic actuator, such as an electromagnet) actuates both changeover switches equally. Thus, it is ensured that both changeover switches are actuated simultaneously by the movement generated by the actuator. This applies in general also for a plurality of changeover switches if the vehicle charging circuit is designed with a plurality of changeover switches.

The vehicle charging circuit can have a filter circuit, a safety circuit and/or a fault current monitoring system. These are, for example, connected between the rectifier circuit and the changeover switch. The changeover switches are connected by way of the filter circuit and by way of the safety circuit, if present, to the rectifier circuit. The fault current monitoring system may be connected to the phases or to the AC voltage side of the rectifier circuit.

In some implementations, the charging connector has a protective conductor contact. This is connected to the filter circuit, the safety circuit and the fault current monitoring system, if present. The safety circuit can have fuses, by way of which the AC voltage side of the rectifier circuit is connected to the charging connector. Furthermore, the safety circuit can have surge protection elements which are connected between the phases of the charging connector or the AC side of the rectifier circuit and a protective conductor potential. These are used for removing overvoltage at the phases toward the protective conductor potential. The protective conductor potential corresponds to a grounding potential. In some examples, the filter circuit corresponds to a multi-phase low-pass circuit. The safety circuit has an individual fuse for each phase in order to protect same from current. The fuse can be an overcurrent protection device or a melting fuse.

In some examples, the charging connector is realized in compliance with a standard for forming vehicle-side vehicle charging connectors. For example, this may be designed in compliance with the CHAdeMO standard or in compliance with IEC 62196 or as a connector for a CCS plug. The charging connector includes a plurality of phase contacts for transmitting a multi-phase AC voltage and may possibly additionally have further contacts for transmitting a DC voltage charging current.

The load connector may be realized in compliance with a standard for forming sockets of an AC supply grid. Such as, the load connector can be designed in compliance with one of the following standards: NEMA n-15 or CEE c/17 where for example n=1 or 5, or where c=4, 5, 7, 16, 17 or a different national or international standard for forming sockets for AC loads. The load connector may be of single-phase design. The load connector has a phase connector and a neutral conductor connector and may have an optional protective conductor connector.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 illustrates an exemplary vehicle charging circuit.

Like reference symbols in the various drawings indicate like elements.

### DETAILED DESCRIPTION

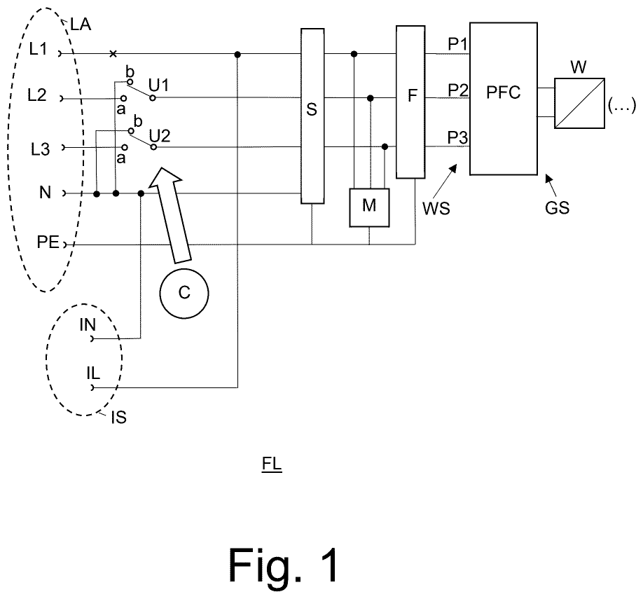

FIG. 1 illustrates a vehicle charging circuit FL which has a charging connector LA for AC and a load connector IS. The charging connector LA is designed to be three-phase, having the phases L1, L2 and L3. The charging connector LA further has a neutral conductor N and a protective conductor PE, which are formed as respective contacts of the charging connector LA. The load connector IS has a neutral conductor IN, a phase IL and can have an (optional) protective conductor. These can be formed as contacts of the load connector IS. The load connector IS is designed for connecting a single-phase AC load.

The vehicle charging circuit FL has a rectifier circuit PFC with 3 phases. There are corresponding phase connectors P1, P2, P3 on the AC side WS of the rectifier circuit PFC. The phase P1 of the rectifier circuit PFC is assigned to the phase L1 of the load connector LA. The phase P2 of the rectifier circuit PFC is assigned to the phase L2 of the load connector LA. The phase P3 of the rectifier circuit PFC is assigned to the phase L3 of the load connector LA. There is only a direct connection free from the changeover switches U1, U2 for the phase L1. For phases L2 and L3, there is a connection by way of one of the changeover switches U1, U2.

The phase P1 or the associated phase connector is (directly) connected to a first phase L1 of the charging connector LA. A disconnect switch can optionally be provided at the location that is provided with a cross; the disconnect switch can also be designed as a changeover switch with a pure in/out function. This phase P1 or associated connector of the rectifier circuit PFC is connected to the phase connector IL of the load connector IS. In other words, the first phase L1 of the charging connector LA is connected, for example in a direct manner, to the phase IL of the load connector IS. This connection can have a fuse.

The neutral conductor connector IN of the load connector IS is connected, in a direct manner, to the neutral conductor N of the charging connector LA. This connection can have a fuse. For the phases P2 and P3, which are not (directly) connected to the load connector IS (for example not to its phase IL), a changeover switch U1, U2 is provided in each case. The first changeover switch U1 optionally connects the phase P2 (or the connector thereof) of the AC side WS of the rectifier PFC to the neutral conductor N or to the associated phase L2 of the charging connector LA. The changeover switch U2 optionally connects the third phase P3 of the rectifier circuit PFC (or the connector thereof) to the neutral conductor N or the third phase L3 of the charging connector LA.

In the switch position a, the phases P2, P3 of the rectifier circuit PFC are individually connected to the associated phases L2, L3 of the charging connector LA. In the switching position b, the phases P2, P3 of the rectifier circuit PFC are connected to the neutral conductor N.

A controller C is connected to the changeover switches U1, U2 in a controlling manner. This activates the switching state a in a charging state and the switching state b in a load supply state. The controller C can also be connected in a controlling manner to the rectifier circuit PFC. In addition to the AC voltage side WS, the rectifier circuit PFC has an opposite DC voltage side GS. A DC-to-DC voltage converter W is connected to this DC voltage side. This may be galvanically isolated. In some examples, a (further) on-board electrical system can be connected to the converter W.

A safety circuit S (multi-phase), an insulation monitoring system M (multi-phase) and a filter circuit F (multi-phase) are illustrated symbolically. The filter circuit F is three-phase and offers low-pass filtering for each phase P1-P3. The insulation monitoring system M is connected to the phase P1 and may possibly also be connected to the phase P3 and/or the phase P2. In addition, the insulation monitoring system M is connected to the protective conductor potential PE, in order thus to be able to detect a fault current. The safety circuit S can have a fuse for each phase, which fuses are provided in series between the respective phases L1-L3 and P1-P3. In addition, the safety circuit S can have a surge protector which for example protects the phases L1 to L3 from the protective conductor potential PE.

A number of implementations have been described. Nevertheless, it will be understood that various modifications may be made without departing from the spirit and scope of the disclosure. Accordingly, other implementations are within the scope of the following claims.

What is claimed is:

1. A multi-phase vehicle charging circuit comprising:
an AC charging connector comprising a neutral conductor;
a rectifier circuit having an AC side, the AC charging connector is connected to the AC side, the AC side includes a first phase, a second phase, and a third phase;
a load AC connector connected to the neutral conductor and to the first phase of the AC side; and
at least one changeover switch connects at least one of the second phase or the third phase of the AC side to the neutral conductor or to an associated phase connector of the AC charging connector.

2. The multi-phase vehicle charging circuit of claim 1, wherein the charging connector comprises:
a first phase connector;
a second phase connector; and
to a third phase connector,
wherein:
the first phase of the AC side of the rectifier circuit is connected to the first phase connector of the AC charging connector,
the second phase of the AC side of the rectifier circuit is connected by way of a first changeover switch to the second phase connector of the AC charging connector, and
the third phase of the AC side of the rectifier circuit is connected by way of a second changeover switch to the third phase connector of the AC charging connector.

3. The multi-phase vehicle charging circuit of claim 2, wherein:
the first changeover switch connects the second phase of the AC side of the rectifier circuit to a second phase connector of the AC charging connector or to the neutral conductor, and
the second changeover switch connects the third phase of the AC side of the rectifier circuit to a third phase connector of the AC charging connector or to the neutral conductor.

4. The multi-phase vehicle charging circuit of claim 1, further comprising:
a controller connected in a controlling manner to at least one changeover switch, wherein:
during a charging state, the controller controls the at least one changeover switch to connect the at least one further phase of the AC side to the associated phase connector, and
during a load supply state, the controller controls the at least one changeover switch to connect the at least one further phase of the AC side to the neutral conductor.

5. The multi-phase vehicle charging circuit of claim 4, wherein:
the first phase of the AC side of the rectifier circuit is connected to a first phase connector of the AC charging connector,
the second phase of the AC side of the rectifier circuit is connected by way of a first changeover switch to a second phase connector of the AC charging connector, and
the third phase of the AC side of the rectifier circuit is connected by way of a second changeover switch to a third phase connector of the AC charging connector,
the controller is connected in a controlling manner to the first and the second changeover switch and controls the two changeover switches to connect the second and the third phase of the AC side of the rectifier circuit simultaneously either to the neutral conductor or simultaneously to the second or third phase.

6. The multi-phase vehicle charging circuit of claim 1, wherein the rectifier circuit includes an active power factor correction filter.

7. The multi-phase vehicle charging circuit of claim 1, further comprising:
a DC-to-DC voltage converter connected to a DC side of the rectifier circuit.

8. The multi-phase vehicle charging circuit of claim 1, which is of three-phase design, wherein:
the second phase of the AC side of the rectifier circuit is connected by way of a first changeover switch to a second phase connector of the AC charging connector, and
the third phase of the AC side of the rectifier circuit is connected by way of a second changeover switch to a third phase connector of the AC charging connector,
the first and the second changeover switch are electromechanical changeover switches, both changeover switches are connected to a common actuator in a force-transmitting manner, which actuator actuates both changeover switches.

9. The multi-phase vehicle charging circuit of claim 1, further comprising:
a filter circuit; and
a safety circuit and/or a fault current monitoring system between the rectifier circuit and the at least one changeover switch.

10. The multi-phase vehicle charging circuit of claim 1, wherein the AC charging connector is in compliance with a standard for forming vehicle charging connectors and the load AC connector is in compliance with a standard for forming a single-phase AC socket.
